(19) United States
(12) Patent Application Publication
(10) Pub. No.: US 2006/0142416 A1
(43) Pub. Date: Jun. 29, 2006

(54) Dispersible colorant and manufacturing method thereof, aqueous ink using the same, ink tank, ink-jet recording apparatus, ink-jet recording method, and ink-jet recording image

(75) Inventors: Junichi Sakai, Tokyo (JP); Yoshio Nakajima, Yokohama-shi (JP); Makoto Aoki, Yokohama-shi (JP); Toshiaki Kaneko, Tokyo (JP); Yoko Ichinose, Tokyo (JP); Masashi Miyagawa, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/311,634

(22) Filed: Dec. 20, 2005

Related U.S. Application Data
(63) Continuation of application No. PCT/JP05/11890, filed on Jun. 22, 2005.

(30) Foreign Application Priority Data
Jun. 22, 2004 (JP) 2004-184038(PAT.)

(51) Int. Cl. C03C 17/00; C09D 11/00

(52) U.S. Cl. 523/160; 523/161

(57) ABSTRACT

A dispersible colorant, including a colorant and a chargeable resin pseudo fine particle having a sulfonic group, which is smaller than the colorant, in which the sulfonic group of the dispersible colorant has a surface functional group density of 100 μmol/g or more, is provided. The dispersible colorant has sufficiently high dispersion stability without causing detachment of the resin component from the colorant, while retaining long-term stability. The use of the dispersible colorant allows an aqueous ink-jet recording ink, which is excellent in discharge stability, an ink tank, an ink-jet recording apparatus, an ink-jet recording method, and an ink-jet recording image to be provided.

This application is a continuation of International Application No. PCT/JP2005/011890, filed Jun. 22, 2005, which claims the benefit of Japanese Patent Application No. 2004-184038, filed Jun. 22, 2004.

### BACKGROUND OF THE INVENTION

1. Field of the Invention

The present invention relates to a dispersible colorant and a method of manufacturing such a material and also relates to an aqueous ink using the material, an ink tank, an ink-jet recording apparatus, an ink-jet recording method, and an ink-jet recording image.

2. Related Background Art

An ink-jet system is a process for recording an image, characters, or the like by making minute liquid droplets of ink to fly out of nozzles onto a recording medium (e.g., paper) with an of various operating principles, and facilitates high speed, low noise, and multicolor recording. Besides, the ink-jet system is characterized in higher versatility of recording patterns and no manipulation for development and fixation, and has rapidly become popular in various applications. In recent years, particularly, technologies for a full color ink-jet recording system with aqueous ink have been remarkably developed, allowing the formation of a color image without inferiority in comparison to any multicolor recording by the conventional plate-making system or any copy formed by the conventional color photographic system. When the number if copies to be printed is small, the ink-jet recording system attains printed products more cheaply than those obtained by the conventional color printing or copy. Therefore, the ink-jet recording system becomes widespread in the filed of full color image-recording.

Colorants used in the aqueous ink-jet recording system mainly include dyes and pigments. In terms of manageability and high chromogenicity for aqueous ink, conventionally, water-soluble dye has been mainly used. However, in late years, the development of ink using, as a colorant for aqueous ink-jet ink capable of realizing higher weather resistance or water resistance of an image, an essentially water-insoluble colorant, particularly pigment has been advanced.

For the use of a water-insoluble colorant, particularly a pigment as aqueous ink-jet recording ink, there is a need of stably dispersing the colorant into water. Conventionally, the process for attaining stability in dispersion typically using a surfactant or a polymer-dispersant (also referred to as a dispersion resin) has been employed. Alternatively, there is proposed a procedure for chemically modifying the surface of a water-insoluble colorant (see, for example, Japanese Patent Application Laid-Open No. H10-195360).

On the other hand, microcapsule type pigments that are covered with resin have been proposed (see, for example, Japanese Patent Application Laid-Open No. H08-183920 and Japanese Patent Application Laid-Open No. 2003-34770). In Japanese Patent Application Laid Open No. 2003-34770, there is disclosed “an aqueous dispersion of colored particles, characterized by comprising a water-insoluble coloring agent, where a water-insoluble coloring agent was dispersed into an aqueous medium in the presence of a dispersant and then added with a vinyl monomer to initiate polymerization, wherein the dispersion shows dispersion stability when the dispersant has dispersed the water-insoluble coloring agent, while the latex caused has poor dispersion stability when the vinyl monomer was polymerized in the presence of only the dispersant”. “When the emulsion polymerization of a vinyl monomer with a dispersion of water-insoluble coloring agent occurs, the dispersant hardly detach from the surface of pigments and the polymerization occurs on the surface of pigments adsorbed by the dispersant because of insufficient affinity of the dispersant to the vinyl monomer or the obtained polymer”. Therefore, “a dispersion of colored particles, in which the surface of pigments is covered, can be obtained in high yield without need of aggregation”. The use of the dispersion of colored particles results in ink-jet recording ink having excellent dispersion stability and print adequacy with no paper-type dependency and little metallic luster, while being excellent in water resistance, light resistance, and abrasion resistance.

### SUMMARY OF THE INVENTION

However, the technology described above may be insufficient in compatibility between dispersion stability and long-term storage stability. Besides, the discharge stability in the process of ink-jet recording may be insufficient. According to the study of the inventors of the present invention, the density of surface functional groups on a colorant should be raised in order to enhance dispersion stability or discharge stability. However, in the conventional procedure using a polymer dispersant or the procedure, in which pigments are covered with a resin, proposed in Japanese Patent Application Laid-Open No. H08-183920, long-term storage stability may be hardly sustained as the resin tends to be detached from the colorant with time because of an increase in hydrophilicity of the resin, in proportion to an increase in acid value of the resin to enhance dispersion stability.

On the other hand, the procedure for chemically modifying the surface of a water-insoluble colorant as proposed in Japanese Patent Application Laid-Open No. H10-195360 has been supposed to be limited in kinds of functional groups to be modified or the density thereof. In other words, a pigment molecule, which is crystallized as being originally insoluble in water, may dissolve out from a pigment particle as the hydrophilic groups are bonded to make the molecule soluble, i.e., the so-called “pigment detachment” occurs, resulting in a remarkable change in hue. In addition, when the pigment molecule does not dissolve out into the aqueous medium, the chemical structure of the surface of the pigment, the chemical structure of the conventional pigment, undergoes drastic changes as the amount of modification increases. In particular, therefore, a pigment having a specific absorption wavelength at optical wavelengths shows variation in its absorption spectrum at optical wavelengths. Thus, the hue of an image on the recording medium varies, thereby resulting in a decrease in image quality. Consequently, substantially direct chemical modification on the surface of the pigment is implicated in the limitations of image quality, dispersion stability, and discharge stability.

An object of the present invention is to solve those problems of the prior art and to provide a dispersible colorant stabilized over a long term and a simple method of manufacturing such a material. Furthermore, another object of the present invention is to provide an aqueous ink which is excellent in discharge stability and suitable for ink-jet recording by using such an excellent dispersible colorant, an ink tank, an ink-jet recording apparatus, an ink-jet recording method, and an ink-jet recording image.

As a result of concentrated study, the inventors of the present invention have, obtained a dispersible colorant in novel shape as a means to solve the above, which retains high dispersion stability without intrinsically requiring any surfactant or polymer dispersant and shows high storage stability n the long term without allowing the resin component to be detached from the colorant. In addition, the novel dispersible colorant has sufficient adhesive property or film-forming property against recording paper. Therefore, by the use of the dispersible colorant, aqueous ink having sufficient discharge stability and dispersion stability for ink-jet recording can be obtained, also allowing the formation of an image having excellent abrasion resistance and marking resistance on the recording paper. Furthermore, by the use of the aqueous ink, the inventors of the present invention have provided an ink tank, an ink-jet recording apparatus, an ink-jet recording method, and an ink-jet recording image.

That is, according to one aspect of the present invention, there is provided a dispersible colorant, including a colorant and a chargeable resin pseudo fine particle having a sulfonic group, which is smaller than the colorant, characterized in that the sulfonic group of the dispersible colorant has a surface functional group density of 100 μmol/g or more.

According to another aspect of the present invention, there is provided a method of manufacturing the above dispersible colorant, characterized by including the step of subjecting a radical polymerizable monomer to aqueous precipitation polymerization in a dispersion aqueous solution of a colorant, thereby allowing a chargeable resin pseudo fine particle having a sulfonic group to fix on the colorant.

According to another aspect of the present invention, there is provided an aqueous ink, characterized by including the above dispersible colorant.

According to another aspect of the present invention, there is provided an ink tank, characterized by including the above aqueous ink.

Furthermore, the present invention provides an ink-jet recording apparatus and an ink-jet recording method each of which is characterized by including forming an ink-jet recording image-using the above aqueous ink and an ink-jet recording image characterized by being formed by the ink-jet recording apparatus.

According to the present invention, a dispersible colorant, which can be independently dispersed in an aqueous medium in a favorable manner by being designed such that the dispersible colorant including a water-insoluble colorant and chargeable resin pseudo fine particles has a surface functional group density of not less than 100 μmol/g with respect to sulfonic groups, can be obtained. Therefore, according to the present invention, then use of the dispersible colorant in the ink-jet recording ink makes it possible to provide an aqueous ink having excellent storage stability and discharge stability, which can be applied in ink-jet recording that imparts excellent image quality to a printed product to be obtained. In addition, according to the present invention, the use of the aqueous ink makes it possible to provide an excellent ink tank ink-jet recording apparatus, ink-jet method, and recording image.

### BRIEF DESCRIPTION OF DRAWINGS

FIGS. 1A and 1B are schematic diagrams for illustrating the basic structure of the dispersible colorant according to the present invention, on which chargeable resin pseudo fine particles having sulfonic groups are fixed.

FIGS. 2A, 2B, 2C, and 2D are schematic diagrams typical steps of the manufacturing method of the present invention, respectively.

FIG. 3 is a schematic diagram for illustrating the steps of purifying chargeable resin pseudo fine particles having sulfonic groups and fixing the particles on the colorant in the manufacturing method of the present invention.

FIG. 4 is an enlarged schematic diagram of chargeable resin pseudo fine particles having sulfonic groups of the present invention viewed from the interface on which the particles are fixed on the colorant.

FIG. 5 is an enlarged schematic diagram of the interface on which the chargeable resin pseudo fine particles having sulfonic groups of the present invention and the colorant are fixed together.

FIGS. 6A and 6B are schematic diagrams of a pigment-detachment phenomenon occurred at the time of direct modification with a hydrophilic group on an organic pigment, represented by Japanese Patent Application Laid-Open. No. H10-195360.

### DESCRIPTION OF REFERENCE NUMERALS

1: colorant
2: chargeable resin pseudo fine particle
3: dispersible resin
4: monomers
5: polymerization initiator aqueous solution
6: dispersible colorant
7: oligomer formed by polymerization of monomers
8: precipitation obtained by water-insolubilization of oligomer
9-1: hydrophilic monomer unit portion in chargeable resin pseudo fine particle
9-2: hydrophobic monomer unit portion in chargeable resin pseudo fine particle
10: bonding portion with colorant
11: interface of the chargeable resin pseudo fine, particle with colorant
12: hydrophilic group directly modified to colorant

### DESCRIPTION OF THE PREFERRED EMBODIMENTS

The present invention will hereinafter be described in detail by examples-of the present invention, which are believed to be best. The term “dispersible colorant” as used herein means a colorant, which is dispersible in water or aqueous ink medium without essentially adding any surfactant or polymer dispersant, or which has an ability of dispersing itself.

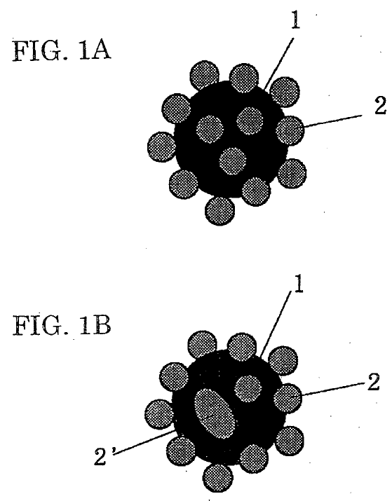

A first aspect of the present invention is a dispersible colorant having a colorant and a chargeable resin pseudo fine particle having a sulfonic group which is smaller than the colorant (hereinafter, simply referred to as a chargeable resin pseudo fine particle), in which the sulfonic group of the dispersible colorant has a surface functional group density of not less than 100 μmol/g. As a more preferable configuration, the dispersible colorant may include a plurality of chargeable resin pseudo fine particles being dotted on the colorant and adhering thereon. In each of FIGS. 1A and 1B, there is shown a schematic diagram of the configuration of the dispersible colorant, where chargeable resin pseudo fine particles 2 adhere on a colorant 1. A part designated as 2′ in FIG. 1B schematically represents a part of chargeable resin pseudo fine particles 2 fixing on the surface of the colorant 1, which are in a state of being fused.

As the colorant fixes chargeable resin pseudo fine particles, the surface of the colorant can be provided with charge from the chargeable resin pseudo fine particles, thereby resulting in a colorant dispersible in water or an aqueous ink medium. Furthermore, the chargeable resin pseudo fine particles used in the present invention have sulfonic groups, so that the dispersibility of the dispersible colorant can be enhanced more. Simultaneously, furthermore, the dispersible colorant of the present invention has excellent adhesiveness to a recording medium owing to the presence of a resin component in the fine particle fixing on the surface of the dispersible colorant. The dispersible colorant of the present invention is not preferably in a state of a simple physical adsorption of a resin component on the colorant. It is preferable that the chargeable resin pseudo fine particle fix on the colorant. Such a configuration prevents the chargeable resin pseudo fine particle from being detached from the surface of the colorant. Therefore, when the dispersible colorant according to the present invention is used in ink, the ink becomes excellent in long-term storage stability.

Here, the term “chargeable resin pseudo fine particle” as described herein refers to a resin aggregate in a state where resin components are strongly aggregated. Preferably, in the resin aggregate, many physical cross-linkages are formed. The resin aggregate is one having a stable configuration as a fine particulate configuration or a fine aggregate close to the fine particle configuration. The details of the chargeable resin pseudo fine particles will be described later.

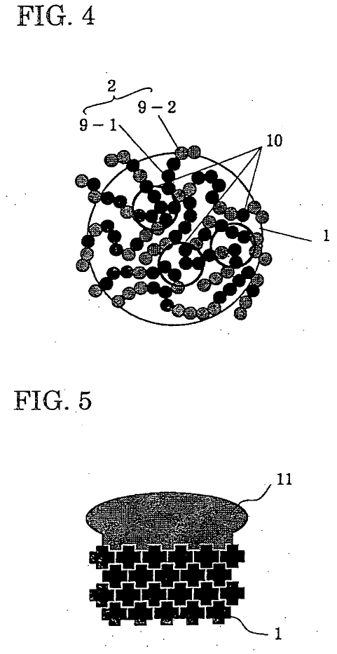

The state of fixing between the colorant and the chargeable resin pseudo fine particle in the present invention depends on a strong interaction between the surface of the colorant and the chargeable resin pseudo fine particle. The state can be expected as the following. In FIG. 4, there is shown an enlarged schematic diagram of the interface between the chargeable resin pseudo fine particle and the colorant. First of all, as shown in FIG. 4, on the interface with the colorant 1, the chargeable resin pseudo fine particle 2 is formed by intertwined polymers composed of various monomer unit compositions (represented by 9-1 and 9-2 in the figure). In this case, the polymers locally take various structures and cause variations in their surface energy states, respectively. Locally, at a point (represented by 10 in the figure) where the surface energy caused from the chemical and surface structures of the colorant and the surface energy caused from the chemical and surface structures of the polymer are well coincident with each other, two interfaces are tightly bound together. Furthermore, on the interface where one of the chargeable resin pseudo fine particles interfaces on the colorant, as shown in FIG. 4, there are plural points such as those represented by 10, where the surface energies are locally coincident. It is expected that a strong interaction among the plural points results in the fixing state of the present invention. In the present invention, such as one represented by 2′ in FIG. 1B, the state in which part of the surface area (e.g., 30%; or more thereof) of the charged pseudo fine particle is in touch with the colorant is referred to as “fusion” for convenience. However, it is one of the forms of fixing, so that the charged pseudo fine particle and the colorant may not be blended in each other in their interface.

In particular, strong interactions are exerted among constituent polymers inside the chargeable resin pseudo fine particle, so that, in some cases, the constituent polymers are twisted up each other and physical linkages are formed among them. Thus, even in the case that the chargeable resin pseudo fine particle has many hydrophilic groups, no chargeable resin pseudo fine particle fixing on the colorant is detached therefrom, or no resin components having hydrophilic groups are continuously dissolved out of the chargeable resin pseudo fine, particle.

In addition, as a merit of allowing the chargeable resin pseudo fine particle to fix on the colorant by the dispersible colorant of the present invention, such a configuration increases the specific surface area of the dispersible colorant and, on many portions thereof, charge on the surface of the chargeable resin pseudo fine particle can be distributed. In this way, the dispersible colorant has a high specific surface area, so that the charge belonging to the chargeable resin pseudo fine particles can be provided as charge on the surface of the dispersible colorant with extremely high efficiency. Furthermore, the chargeable resin pseudo fine particle has a sulfonic group having high degree of ionic dissociation so that the surface charge due to the above configuration can be raised still more. In other words, the above configuration of the dispersible colorant of the present invention is a configuration that more efficiently provides the surface of the dispersible colorant with more surface change higher. Therefore, the above configuration of the dispersible colorant of the present invention can provide higher dispersion stability in comparison with the configuration of a colorant covered with a resin as typified by Japanese Patent Application Laid-Open No. H08-183920.

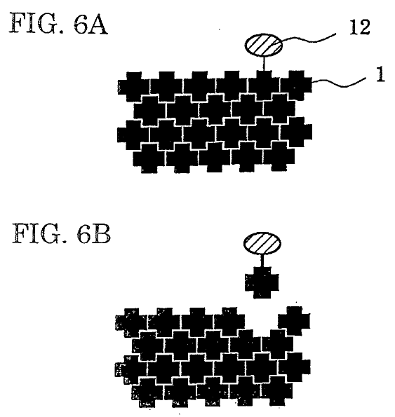

Even in the case that the colorant used in the present invention is an organic pigment provided as a dispersible colorant, as described above, a plurality of interaction points of the chargeable resin pseudo fine particles are randomly distributed when the particles fix on the colorant. Thus, the above chargeable resin pseudo fine particles can fix over several pigment molecules in the pigment crystal (FIG. 5). Therefore, the “pigment detachment”, which occurs when the pigment molecule is locally imparted with hydrophilicity, shown in FIGS. 6A and 6B, does not occur in the present invention. Preferably, when the organic pigment is used as a colorant, the size of the chargeable resin pseudo fine particle may be adjusted so as to be smaller than the pigment particle but larger than the pigment molecule. Consequently, a dispersible colorant using an organic pigment provided with high dispersibility can be obtained without disturbing the crystal structure of the pigment.

The dispersible colorant in the state where the colorant “fixes” the chargeable resin pseudo fine particles can be confirmed by the procedure with three separation stages for facility as described below. At first, the first separation separates the colorant to be confirmed from other water-soluble components (including a water-soluble resin component) contained in ink or a water dispersion medium. Then, the second separation separates the colorant included in a sediment generated by the first separation from a water-insoluble resin component. Furthermore, the third separation separates the resin component being absorbed weakly from the dispersible colorant fixing chargeable resin pseudo fine particles. Subsequently, the quantitative determination of the resin component contained in the supernatant obtained by the third separation and a comparison between the sediment from the second separation and the sediment from the third separation are carried out, respectively. Consequently, the fixation between the colorant and the chargeable resin pseudo fine particle can be confirmed.

More concretely, for example, the fixation can be confirmed by the following conditions. 20 g of ink or a water dispersion medium is taken and then prepared so that the mass of the total solid content can be about 10%, followed by the first separation by means of a centrifugal separator under the conditions of 12,000 r.p.m for 60 minutes. Among the separated products, the sediment of the lower layer containing the colorant is re-dispersed in about three volumes of pure water and then subjected to the second separation, provided that it is recentrifuged at 80,000 r.p.m for 90 minutes. The sediment of the lower layer containing the colorant re-dispersed in three volumes of pure water is subjected to the third separation, provided that it is recentrifuged at 80,000 r.p.m for 90 minutes, allowing the sediment of the lower layer containing the colorant to be re-dispersed in three volumes of pure water. Each of the sediments from the second and third separations is taken so as to be about 0.5 g in solid content, followed by drying at 30° C. for 18 hours under reduced pressures. The resulting product is observed by a scanning electron microscope at 50,000 times magnification. It is determined that resin pseudo fine particles fix on the colorant when the plural fine particulate substances or minute aggregates based thereon, which are attached on the surface of the observed dispersible colorant, were confirmed and when the sediments from the second and third separation have the same configuration. Furthermore, the supernatant fraction of the upper layer obtained by the third separation was gently taken so as to become almost half in volume and the percent mass of a solid content is then calculated from variations in mass before or after drying at 60° C. for 8 hours. When the variations are within less than 1%, the resin pseudo fine particles may not be detached. Thus, it can be judged that the resin pseudo fine particles have fixed on the dispersible colorant.

The conditions of the respective separations described above are preferable examples. Any of other separation methods or separation conditions may be applied as a method of determining the dispersible colorant of the present invention as far as it is a procedure for attaining the intents of the first, second, and third separation procedures. In other words, the first separation intends to separate the colorant included in ink and a water dispersion medium and the resin component adsorbed thereon from the water soluble component. The second separation intends to separate the colorant and the resin component fixed on the colorant from other resin components adsorbed on the colorant. Furthermore, the third separation intends to confirm that the resin component fixed on the colorant is not detached therefrom. Needless to say, any of other known or newly developed separation procedures may be used as far as it is a separation procedure for attaining the respective intents of the first, second, and third separation procedures. Besides, the number of the separation procedures to be applied may be smaller or larger than three.

The second characteristic feature of the dispersible colorant of the present invention is that the dispersible colorant having the colorant 1 and the chargeable resin pseudo fine particle 2 can be independently dissolved in an aqueous medium. As described above, the dispersible colorant of the present invention is a self-dispersible colorant, which is essentially dispersible in water or aqueous ink in a stable manner even without the aid of another substance such as a surfactant or a polymer dispersant. The definition and criterion of such a term will be described later in detail. Therefore, the dispersible colorant of the present invention does not require the addition of a polymer dispersant or any other resin component, which may be detached in the long term, or of a surfactant component, for the purpose of stabilizing the dispersion of the colorant. As a result, when the dispersible colorant is used as the aqueous ink, the design freedom with respect to any component other than the dispersible colorant becomes large. For instance, aqueous ink can be prepared as one which is capable of attaining sufficiently high printing density even on a recording medium having high permeability to ink, such as normal paper.

The self dispersibility of the dispersible colorant of the present invention can be confirmed, for example, by the following method. The ink or water dispersion medium in which the colorant is being dispersed is diluted 10-fold in pure water and then condensed up to the original concentration using an ultrafilter membrane with a molecular weight cut off of 50,000. Subsequently, the concentrate is separated by a centrifugal separator under the conditions of 80,000 r.p.m for 90 minutes, and a sediment is then collected and re-dispersed in pure water. At this time, the sediment which can be re-dispersed well is defined as one having self dispersibility. It is collectively determined whether or not the sediment is re-dispersed well by the criteria, for example, as follows: the uniform dispersion is observed by sight; any conspicuous sediment occurs while standing for 1 or 2 hours; even if the sediment has occurred, it can be restored by shaking; when the diameters of the dispersed particles are measured by a dynamic light scattering method, the average particle size of the dispersed particles is within the range of 2 folds of the particle size before the operation.

As described above the dispersible colorant of the present invention has the form having a high specific surface area as the colorant fixes the chargeable resin pseudo fine particle. Besides, much electric charge is provided on the wide surface of the dispersible colorant, so that excellent storage stability can be realized when the dispersible colorant is used in ink. Furthermore,the dispersible colorant on which at least the chargeable resin pseudo fine particle having a sulfonic group fixes, which constitutes the dispersible colorant of the present invention, has a high specific surface area owing to the configuration of the material as well as a sulfonic group having high degree of ionic dissociation. Therefore, the colorant becomes a dispersible colorant which is stable in dispersion while retaining high surface potential when the colorant is used in ink. As a result, the dispersion stability and storage stability of the dispersible colorant can be attained. In addition, by using the dispersible colorant, the dispersion stability, storage stability, and discharge stability of the aqueous ink-jet recording ink can be enhanced. Therefore, the chargeable resin pseudo fine particles provide further preferable results when many (plural) chargeable resin pseudo fine particles are dotted and fix on the colorant. In particular, it is desirable that there be a predetermined distance between the fixing chargeable resin pseudo fine particles, preferably with uniform distribution for the colorant, more preferably in the state that part of the surface of the colorant particle is exposed.

Being under such conditions can be confirmed such that the dispersible colorant according to the present invention is observed by a transmission electron microscope or a scanning electron microscope. In other words, the observed colorant can be determined as a dispersible colorant to be preferably used in the present when there is observed the plural chargeable resin pseudo fine particles which fixes on the surface of the colorant while keeping a predetermined distance between the particles, or there is observed the surface of the colorant which is being exposed between the chargeable resin pseudo fine particles fixing thereon. Furthermore, the chargeable resin pseudo fine particles may be observed such that they are partially in close proximity to one another or fused together. However, in any of those cases, there is a certain distance between the chargeable resin pseudo fine particles as a whole and there are some exposed portions of the surface of the colorant. Besides, when such states are distributed, it will be evident for a person skilled in the art that the chargeable resin pseudo fine particles are deemed to be dotted and fix on the colorant.

According to the investigation conducted by the inventors of the present invention, it has become evident that the aqueous ink containing the dispersible colorant according to the present invention as described above shows excellent quick-drying property. This reason is hot sure, but it may depend on the following mechanism. As described above, the dispersible colorant is dispersed in ink such that the chargeable resin pseudo fine particles fix on the surface of the colorant. When the ink reaches a recording medium, the aqueous solvent in the ink (hereinafter, referred to as an ink solvent) is absorbed into fine pores on the recording medium (gaps between cellulose fibers in the case of normal paper, while fine pores in a reception layer of coated or grazed paper) through capillary phenomenon. Then, on the colorant to be used in the present invention, owing to the structural features of the material, there are chargeable resin pseudo fine particles dotted on the portion where the colorants contact with each other, thereby forming many fine gaps. A capillary phenomenon acts on the ink solvent existing between colorants, so that the ink solvent between the colorants can be quickly absorbed in a recording medium. Among the dispersible colorants according to the present invention, one configured such that chargeable resin pseudo fine particles are dotted on its surface provides aqueous ink which shows more preferable quick drying property.

Therefore, it is expected that the quick-drying property can be achieved by the mechanism described above.

The dispersible colorant according to the present invention has a characteristic feature in that the surface functional group density of a sulfonic group of the dispersible colorant is 100 μmol/g or more. In contrast, it may be unfavorable when the surface functional group density of a sulfonic group is less than 100 μmol/g because sufficient dispersion stability or discharge property may not be obtained when dispersible colorant is used in ink. Furthermore, the surface functional group density of a sulfonic group is preferably in the range of 100 to 500 μmol/g. When the surface functional group density of a sulfonic group exceeds 500 μmol/g, the dispersion stability of the dispersible colorant becomes too high. Therefore, a density in excess of 500 μmol/g is unfavorable because of a decrease in color density of a recording medium such as normal paper having high permeability.

When the dispersible colorant according to the present invention, which has been described above, is used in ink, as shown in FIGS. 1A and 1B, the dispersible colorant favorably resides in the ink such that the chargeable resin pseudo fine particles 2 fix on the surface of the water-insoluble colorant 1. Therefore, the colorant may adhere to recording paper and the adjacent colorant on the recording paper through the chargeable resin pseudo fine particles fixed on the surface of the colorant. Consequently, a printed product obtained using the aqueous ink-jet recording ink according to the present invention is capable of realizing excellent abrasion resistance and marking resistance.

(Colorant)

The dispersible colorants according to the present invention and colorants provided as essential components of ink-jet recording ink in which the dispersible colorants are used will be described, respectively. The water-insoluble colorants used in the present invention include any of those which can be water-insoluble and stably dispersed in water together with dispersants, such as hydrophobic dyes, inorganic pigments, organic pigments, metal colloids, and colored resin particles Preferably, the colorant has a dispersion particle size of 0.01 to 0.5 μm (10 to 500 nm), particularly preferably 0.03 to 0.3 μm (30to 300 nm). A colorant having a dispersion particle size of more than 0.5 μm is not favorably used for printing a more precise image because a discharge port of an ink-jet recording apparatus is more likely to clog. On the other hand, when the colorant is remarkably smaller than that range, sufficient weather resistance or the like of the image, which is an advantageous feature of using the water-insoluble colorant, may not be obtained.

Examples of the inorganic pigment that may be usefully used in the present invention include carbon black, titanium oxide, zinc white, zinc oxide, tripon, cadmium red, colcothar, molybdenum red, chromium vermilion, molybdate orange, chromium yellow, chromium yellow, cadmium yellow, yellow oxide, titanium yellow, chromium oxide, pridian, cobalt green, titanium cobalt green, cobalt chromium green, ultramarine, ultramarine blue, iron blue, cobalt blue, cerulean blue, manganese violet, cobalt violet, and mica.

Examples of the organic pigment that may be usefully used in the present invention include various pigments such as azo-based, azomethine-based, polyazo-based, phthalocyanine-based, quinacridone-based, anthraquinone-based, indigo-based, thioindigo-based, quinophthalon-based, benzimidazolon-based, isoindoline-based, and isoindolinon-based pigments.

Examples of an organic water-insoluble color material that may be used in the present invention include hydrophobic dyes such as azo-based, anthraquinone-based, indigo-based, phthalocyanine-based, carbonyl-based, quinonimine-based, methine-based, quinoline-based, and nitro-based dyes. Of those, a disperse dye is particularly preferable.

(Chargeable Resin Pseudo Fine Particle Having Sulfonic Group)

Any of resin fine particles constructed of any resin component conventionally used may be employed as a chargeable resin pseudo fine particle having a sulfonic group, which is one of the characteristic features of the present invention. The chargeable resin pseudo fine particle may be defined as one which is self-dispersible in an aqueous medium and the dispersion particle size thereof in water can be measured by means of a light-scattering method or the like, preferably the median value of the dispersion particle sizes is in the range of 10 to 200 nm. Furthermore, in terms of the long-term storage stability of the aqueous ink-jet recording ink, the polydispersion index of the dispersion particle size is further preferably limited to less than 0.2. When the median value of the dispersion particle sizes is larger than 200 nm or when the polydispersion index of the dispersion particle size is larger than 0.2, an original purpose of finely stabilizing the dispersion of the water-insoluble colorant may be hardly attained in a sufficient manner. In addition, when the median value of the dispersion particle sizes is less than 10 nm, the resin pseudo fine particle hardly retains its configuration and the resin tends to be dissolved in water, so that an advantage of the present invention cannot be obtained.

The resin component that constitutes the chargeable resin pseudo fine particle is not specifically limited as far as it is a resin containing a sulfonic group. Any resin component, such as any of natural or synthetic polymers conventionally used or novel polymers developed for the present invention, can be employed without any specific limitation. Particularly, in terms of the use in general and simplified functional design of a resin fine particle, a polymer or co-polymer containing monomer components having radical polymerizable unsaturated bonds, which may include an acrylic resin or a styrenic/acrylic resin, can be employed.

Examples of the hydrophilic radical polymerizable unsaturated monomer having a sulfonic acid group used desirably in the present invention (hereinafter, referred to as a monomer) include styrenesulfonate, sulfonate-2-propylacrylamide, acrylate-2-ethyl sulfonate, methacrylate-2-ethyl sulfonate, and butylacrylamide sulfonate, and salts thereof.

Examples of a hydrophilic monomer include: a monomer having a carboxyl group such as acrylic acid, methacrylic acid, crotonic acid, ethacrylic acid, propylacrylic acid, isopropylacrylic acid, itaconic acid, or fumaric acid, and salts thereof; and a monomer having a phosphonic acid group such as methacrylate-2-ethyl phosphonate or acrylate-2-ethyl phosphonate each of which may be used in combination with the monomer having a sulfonic acid group described above.

Examples of a monomer classified as a hydrophobic monomer include: (meth)acrylates such as methyl acrylate, ethyl acrylate, isopropyl acrylate, acrylate-n-propyl, acrylate-n-butyl, acrylate-t-butyl, benzyl acrylate, methyl methacrylate, ethyl methacrylate, isopropyl methacrylate, methacrylate-n-propyl, methacrylate-n-butyl, isobutyl methacrylate, methacrylate-t-butyl, tridecyl methacrylate, and benzyl methacrylate; styrene-based monomers such as styrene, α-methyl styrene, o-methyl styrene, m-methyl styrene, p-methyl styrene, and p-tert-butyl styrene; itaconates such as benzyl itaconate; maleates such as dimethyl maleate; fumarates such as dimethyl fumarate; acrylonitrile; methacrylonitrile; and vinyl acetate. Conventional or novel other various oligomers, macromonomers, and the like may be also used without limitation.

In the present invention, particularly, it is preferable to construct the chargeable resin pseudo fine particle having a sulfonic group from a copolymer composed of monomer components including at least one hydrophilic monomer having a sulfonic group and at least one hydrophobic monomer in terms of obtaining aqueous ink-jet recording ink having dispersion stability and favorable printing characteristics. That is, when a charged resin fine particle is prepared, for example, it is possible to suitably control various characteristics or the like of the chargeable resin pseudo fine particle fixing on the surface of the colorant through many control elements such as the type and concentration of a polymerization initiator to be used, and the types of monomers to construct in the copolymer and a copolymerization ratio thereof. In this case, good fixing property to the colorant and thermal stability can be imparted by constructing the particle with at least one type of a hydrophobic monomer. On the other hand, good configuration control and dispersion stability can be imparted by constructing the particle with at least one type of a hydrophilic monomer having a sulfonic group. Therefore, the monomers described above are used together to provide a resin fine particle which can consistently fix to the colorant sufficiently and has consistently good dispersion stability. On condition that the above conditions are satisfied, furthermore, by suitably selecting monomer species, that constitute a resin fine particle and also selecting a copolymerization ratio, dispersible colorant and/or chargeable resin pseudo fine particles fixing on the colorant can be provided with additional functionalities.

(Synthesis of Resin Pseudo Fine Particle Having Sulfonic Group and Fixation Thereof to Water-Insoluble Colorant)

A method of synthesizing the resin pseudo fine particle described above and a method of allowing the particle to fix on the colorant described above can be carried out by the conventional method for the synthesis of chargeable resin pseudo fine particles or the conventional method of making a complex between the chargeable resin pseudo fine particles and the colorant, where their procedures and processes are well known in the art. Here, as a result of intensive study, the inventors of the present invention have finally found out a simple method of manufacturing a dispersible colorant in the state of fixing the chargeable resin pseudo fine particle having the sulfonic group thereto and being independently dispersed, which is characteristic of the present invention, and a simple method of manufacturing aqueous ink-jet recording ink, which contains the dispersible colorant. Hereinafter, the method of manufacturing the dispersible colorant of the present invention and the method of manufacturing aqueous ink-jet recording ink, which can be favorably carried out in the present invention, particularly a preferable method of manufacturing a dispersible colorant in the state of fixing the chargeable resin pseudo fine particle having the sulfonic group thereto and being dispersed independently.

The investigation conducted by the inventors of the present invention has revealed that the dispersible colorant having characteristic features described above can be manufactured very simply by application of an aqueous precipitation polymerization method under the conditions below. That is, the method involving allowing the chargeable resin pseudo fine particles to fix on the colorant is provided, by the step in which: at first, a water dispersion medium for a colorant is prepared by dispersing an insoluble colorant into a water-soluble resin that functions as a dispersant; and then a radical polymerizable monomer is subjected to aqueous precipitation polymerization in the water dispersion medium. The dispersible colorant obtained through the step is composed of a colorant on which chargeable resin pseudo fine particles having sulfonic groups, which have been synthesized in the aqueous precipitation polymerization step described above, are strongly fixed in the state of being uniformly dotted. Besides, the dispersible colorant is excellent in dispersion stability by itself. In the step of aqueous precipitation polymerization, the characteristic features of the chargeable resin pseudo fine particle having the sulfonic group can be simply adjusted to a preferable configuration as described above. In this case, furthermore, the state of fixation with the colorant, which is one of the characteristic features of the present invention, can be attained well. Hereinafter, preferred embodiments of the above manufacturing method will be described in detail.

(Dispersion of Water-Insoluble Colorant)

At first, the colorant favorably used in the present invention as described above is prepared in a water dispersion medium using a dispersant. For the dispersant for dispersing the colorant into an aqueous solution, any of ionic or nonionic ones or the like can be used as far as it is any of conventional polymer dispersants and water-soluble polymers.

In the process of preparing the water-insoluble colorant in the water dispersion medium through the dispersant, the colorant is dispersed such that the dispersion particle size of the colorant is in the range of 0.01 to 0.5 μm (10 to 500 nm), particularly preferable in the range of 0.03 to 0.3 μm (30 to 300 nm). The dispersion particle size in the process substantially influences the dispersion particle size of the colorant on which chargeable resin pseudo fine particles having sulfonic groups to be obtained are fixed and then it is preferable to be within the above range in terms of ink-jet adequacy and dispersion stability and in terms of the weather resistance of an image.

Furthermore, the distribution of dispersion particle sizes of the water-insoluble colorant to be used in the present invention is preferably of mono dispersion as possible. According to the investigation conducted by the inventors of the present invention, for attaining good dispersion stability and discharge stability of the ink-jet recording ink, it is preferable to use one in which the polydispersion index of the colorant is in the range of 0.25 or less. Here, the particle size of the colorant in the state of being dispersed varies depending on various measurement systems. In particular, there is an extremely small chance that the organic pigment is spherical. In the present invention, however, the particle size and the polydispersion index used are obtained by the measurement, which is performed on the basis of a dynamic light scattering method with ELS-800 manufactured by Otsuka Electronics Co., Ltd., and the results are then subjected to a cumulant analysis.

The method of dispersing the water-insoluble colorant is not specifically limited as far as it is any of conventionally known methods using the dispersant as described above among those by which the colorant can be stably dispersed in water under the conditions as described above. Alternatively, it may be a dispersion-method which is newly developed for the present invention. In general, for example, when the water-insoluble colorant is a pigment, a suitable dosage of the polymer dispersant used is in the range of 10% to 130% by weight with respect to the pigment.

Even if a method using a surfactant as a dispersant is employed as a method of dispersing the colorant other than the method described above, manufacturing methods which will be described sequentially below may be applied on such a method. However, in the case of using the surfactant, because of strong adsorbability to the colorant compared with that of the polymer dispersant, the surfactant may inhibit the fixation of a chargeable resin pseudo fine particle having a sulfonic group. In contrast, when a surfactant having weak adsorbability to the colorant is used, there is a need of loading a large amount of the surfactant for sufficiently dispersing the colorant. In this case, the chargeable resin pseudo fine particle can be prevented from attaching to the colorant. In addition, even if the colorant fixed with the chargeable resin pseudo fine particle having the sulfonic-group is obtained, when it is used in ink-jet recording ink, the remaining surfactant may induce the permeation of the colorant into a recording medium, so that high image density cannot be obtained. From those reasons, it is desirable to use any polymer dispersant when the manufacturing method of the present invention is applied.

The method of dispersing the colorant used in the present invention is not specifically limited as far as it is any of those conventionally used for the respective colorants including: dispersers such as a paint shaker, a sand mill, an agitator mill, and a three-roll mill; high-pressure homogenizers such as a microfluidizer, a nanomizer, and a multimizer; and an ultrasonic disperser.

(Radical Polymerization Initiator)

For the radical polymerization initiator used in the present invention, any kind of the initiators is available as far as it is a water-soluble radical polymerization initiator commonly used. Concrete examples of the water-soluble radical polymerization initiator include persulfate. Alternatively, the initiator may be a redox initiator provided as a combination of a water-soluble radical polymerization initiator and a reducing agent. Concretely, the initiator is designed and used so as to be an optimal combination in consideration of colorants, dispersants, and monomers, which are listed in the above description. Preferably, a polymerization inhibitor that provides a polymerization initiator residue having the same signal as that of the surface characteristic of a water-insoluble colorant on which chargeable resin pseudo fine particles to be obtained has fixed. For instance, in the present invention, for obtaining the water-insoluble colorant having the sulfonic group, desired surface charge can be effectively obtained by choosing one that leads to a neutral or anionic initiator residue.

(Radical Polymerizable Monomer)

A radical polymerizable monomer, which can be used in the manufacturing method of the present invention, is one of the components that constitute a chargeable resin pseudo fine particle having a sulfonic group through the aqueous precipitation polymerization. Thus, the radical polymerizable monomer may be suitably selected depending on the characteristic features of the chargeable resin pseudo fine particle to be obtained and the characteristic features of the colorant on which the chargeable resin pseudo fine particle has fixed. In the manufacturing method of the present invention, any of the radical polymerizable monomers conventionally known in the art or any of radical polymerizable monomers newly developed for the present invention can be employed.

(Aqueous Precipitation Polymerization)

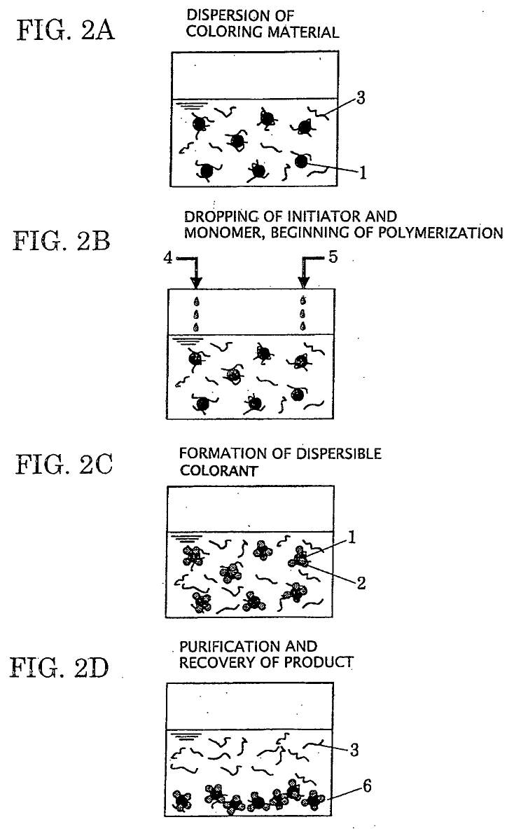

Next, a preferred embodiment of aqueous precipitation polymerization, which is the process of synthesizing a chargeable resin pseudo fine particle having a sulfonic group, which is one of the characteristic features of the present invention, and then fixing the chargeable resin pseudo fine particle on a colorant. FIGS. 2A and 2B are process diagrams which schematically illustrate process flow charts of the manufacturing method described above, respectively. In the present process, the steps to obtain the dispersible colorant can be thought of as follows. At first, as shown in FIG. 2A, a colorant 1 is dispersed into an aqueous solution with a dispersant 3 to prepare a dispersion aqueous solution. In this case, the colorant is adsorbed to the dispersant and thus stabilized in dispersion. Therefore, the adsorption is in a thermally balanced state. Next, the dispersed product, which has been prepared in FIG. 2A, is heated while being stirred, and is added with monomer components 4 together with, for example, an aqueous radical polymerization initiator 5 (see FIG. 2B). The added aqueous radical polymerization initiator is heated up, thereby being cleaved to generate radicals which contribute to a reaction between a hydrophobic monomer dissolved in small amount in an aqueous phase and a water-soluble monomer in the aqueous phase among monomer components added in the dispersion aqueous solution.

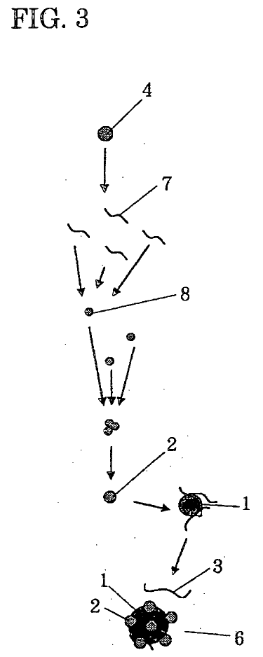

FIG. 3 is a schematic diagram that illustrates the steps from the polymerization of the monomers 4 to the generation of a dispersible colorant. When the reaction of the monomers 4 described above has proceeded, an oligomer 7 generated by the polymerization reaction of the monomer components becomes insoluble in water and is then precipitated from the aqueous phase (8 in the figure). However, the oligomer precipitated at this time does not have sufficient dispersion stability, so that it may be combined with other oligomers to form a chargeable resin pseudo fine particle 2 having a sulfonic group. The chargeable resin pseudo fine particles 2 undergo heterogeneous aggregation using the hydrophobic surface of the colorant 1 in the dispersion aqueous solution as a nucleus, resulting in strong adsorption caused by the hydrophobic interaction between the surface of the colorant and the resin component that constitutes the chargeable resin pseudo fine particle 2. At this time, inside the chargeable resin pseudo fine particle 2, the polymerization reaction is still undergoing. Therefore, the particle changes its form to be more stable with respect to energy while increasing the number of adsorption points with the colorant 1. Simultaneously, the inside of the chargeable resin pseudo fine particle is highly, physically cross-linked, so that the particle can be adsorbed to the colorant 1 in the most stable manner, thereby resulting in a fixing state. On the other hand, the colorant 1 becomes stable as plural chargeable resin pseudo fine particles 2 are fixed on the colorant 1 one after the other. Thus, the dispersant 3, which has been in the balanced state, detaches from the surface of the colorant (see FIG. 2D and FIG. 3).

In FIG. 4, there is shown a schematic diagram viewed from the interface on which the chargeable resin pseudo particles 2 are fixed on the colorant 1. In the chargeable resin pseudo fine particle 2, which is an aggregate of resin components, there are hydrophilic monomer units 9-1, hydrophobic monomer units 9-2, and so on, which are arbitrarily distributed. Therefore, there are distributed local surface energies and an infinite number of adsorption points 10 that correspond to the surface energies of the colorant 1.

FIG. 5 shows an enlarged schematic diagram of the interface between the chargeable resin pseudo fine particles and the colorant. The interface 11 of the chargeable resin pseudo fine particle is adsorbed to the adsorption point 10 shown in FIG. 4, while being configured so as to be fit to the surface configuration of the colorant 1, thereby resulting in stable fixation. As described above, in this process, the polymerization reaction still proceeds in the chargeable resin pseudo fine particle. Therefore, the chargeable resin pseudo fine particle is adsorbed while keeping the adsorption in stable, so that the fixation thereof to the colorant 1 can be attained. From the process as described above, the dispersible colorant 6 constructed as described above can be easily formed (see FIG. 2D). At this time, in a system where the chargeable resin pseudo fine particle has sufficient surface charge and attains its self-dispersibility, electrostatic repulsion acts between the chargeable resin pseudo fine particles, mutually, during the steps of adsorption and fixation to the colorant with the hetero aggregation.

Therefore, the chargeable resin pseudo fine particles 2 are dotted and fixed on the colorant 1, thereby becoming a preferred configuration as described above.

The polymerization reaction conditions may vary depending on the natures of the polymerization inhibitor, dispersant, and monomer, which are used in the present invention. For instance, the reaction temperature is set to 100° C. or lower, preferably in the range of 40° C. to 80° C. (both inclusive). In addition, the reaction time period is one hour or more, preferably in the range of 6 hours to 30 hours (both inclusive). The agitating speed during the reaction is in the range of 50 to 500 rpm (both inclusive), preferably in the range of 150 to 400 rpm (both inclusive).

In the step described above, particularly, when a chargeable resin pseudo fine particle having a sulfonic group is obtained by polymerizing at least one hydrophobic monomer with a hydrophilic monomer containing at least a sulfonic group, preferably the monomer component is favorably added to the water dispersion medium of the water-insoluble colorant that contains the aqueous radical polymerization initiator. For uniformly obtaining the desired chargeable resin pseudo fine particles having the sulfonic groups from a mixture of monomers having different natures, such as the hydrophobic and hydrophilic monomers, it is favorable to retain the copolymerization ratio of the monomers having different natures at constant. When the excess amount of the monomer mixture is added to the polymerization system in comparison with the amount of monomers to be consumed for a polymerization reaction in a given amount of time, only the specific monomer species are polymerized in advance and the remaining monomers then tend to polymerize after the consumption of monomers previously polymerized. In this case, large nonuniformity occurs in the natures of the chargeable resin pseudo fine particles having the sulfonic groups, which have been generated.

Of the chargeable resin pseudo fine particles, particularly, no fixation of those having large contents of hydrophilic monomer components to the surface of a water-insoluble colorant occurs in some cases. Furthermore, no precipitation of the resin component containing hydrophilic monomer components in large quantities occurs in some cases because of its high hydrophilicity, and the resin component may remain as a water-soluble resin component in the system without forming the chargeable resin pseudo fine particles having sulfonic groups. On the other hand, the monomer component is added dropwise to the water dispersion medium of the water-insoluble colorant containing an aqueous radical polymerization initiator, so that the copolymerization ratio between the hydrophobic monomer and the hydrophilic monomer can be always kept at constant. Therefore, the chargeable resin pseudo fine particles constructed with the desired copolymerization ratio can be obtained uniformly.

Furthermore, when the anionic monomers containing sulfonic groups and the like are added to the polymerization system, the monomers may cause aggregation because the monomers become partially destabilized depending on the characteristic features of the polymer dispersant for dispersing the colorant. For preventing such aggregation, there is also a preferable embodiment in which the anionic monomer may be neutralized in advance and added in the state of sodium salt or potassium salt.

For preparing ink-jet recording ink using the colorant on which the chargeable resin pseudo fine particles having sulfonic groups are fixed, which has been obtained in the above process, it is preferable to carry out an additional process of purification in addition to the above process in this case, a method used for the purification may be an optimum method selected from those generally used in the art. For instance, it is also a preferable embodiment to carry out purification with a centrifugal separation or ultrafiltration method.

(Aqueous Ink)

The characteristic feature of the aqueous ink according to the present invention is to contain the dispersible colorant according to the present invention as described above. When the water-insoluble colorant is a pigment, typically, the content of the pigment is 0.1 to 20% by weight, preferably 0.3 to 15% by weight with.respect to ink. Furthermore, favorably, water or a water-soluble organic solvent may be contained as an aqueous medium Besides, a penetrating agent, an antiseptic agent, a mildewproofing agent, or the like may be included to help permeability to the recording medium.

(Recording Image)

The ink-jet recording image of the present invention can be formed on a recording medium by an ink-jet recording apparatus as described below using the aqueous ink according to the present invention. Any medium such one that can be subjected to ink-jet can be used as the recording medium of the present invention without any limitation.

(Image-Recording Method and Recording Apparatus)

The dispersible colorant and the aqueous ink of the present invention can be used in an ink-jet discharging type head and can be useful for an ink tank in which such ink is stored or filling ink for the ink tank. In particular, out of the different types of ink-jet recording heads, the present invention exerts excellent effects in bubble jet-type recording head and recording apparatus.

As the typical arrangement and principle of the ink-jet recording system, those practiced by use of the basic principle disclosed in, for example, U.S. Pat. Nos. 4,723,129 and 4,740,796 is preferable. The above system is applicable to either one of so-called on-demand type and continuous type. Particularly, in the case of the on-demand type, the system is effective because, by applying at least one driving signal, which corresponds to printing information and gives a rapid temperature rise exceeding nucleate boiling, to each of electrothermal transducers arranged in correspondence with a sheet or liquid channels holding ink, heat energy is generated by the electrothermal transducer to effect film boiling on the heat acting surface of the recording head and consequently, a bubble can be formed in the ink in one-to-one correspondence with the driving signal. By discharging the ink through a discharge opening by the growth and shrinkage of the bubble, at least one droplet is formed. The driving signal is more preferably applied as a pulse signal because the growth and shrinkage of the bubble can be attained instantly and adequately to achieve discharge of the ink with the particularly high response characteristics. As the pulse driving signal, signals disclosed in U.S. Pat. Nos. 4,463,359 and 4,345,262 are suitable. Note further that excellent printing can be performed by using the conditions described in U.S. Pat. No. 4,313,124 of the invention, which relates to the temperature rise rate of the heat acting surface.

As an arrangement of the recording head, in addition to the arrangement as a combination of discharge nozzles, liquid channels, and electrothermal transducers (linear liquid channels or right angle liquid channels) as disclosed in the above specifications, the arrangement using U.S. Pat. Nos. 4,558,333 and 4,459,600, each of which discloses the arrangement having a heat acting portion arranged in a flexed region, is also included in the present invention. In addition, the present invention is effectively applicable to the structure (e.g, Japanese Patent Application Laid-Open No. S59-123670) in which a common discharge orifice is used as the discharge outlet for plural electrothermal transducers. Furthermore, a so-called full-line type recording head having a length corresponding to the maximum recording width of the recording apparatus may be configured by combining plural heads to fill the length or may be configured as an integrally formed single head. The present invention can more effectively exert the above effects.

In addition, the present invention is applicable to the use in an exchangeable chip type recording head which can be electrically connected to the apparatus main unit and can receive an ink from the apparatus main unit upon being mounted on the apparatus main unit and a cartridge type recording head which is integrally arranged on the recording head itself. It is preferable to add recovery means, preliminary auxiliary means, or the like, which is provided as an arrangement of the recording apparatus to which the present invention is applicable, to the recording head since the effects of the present invention can be further stabilized. Concrete examples of such means include, for the head, capping means, cleaning means, pressurization or suction means, preliminary heating means using electrothermal transducers, another heating element, or a combination thereof, and means for preliminary discharge for discharge separate from recording.

### EXAMPLES

Next, the present invention will be further described concretely with reference to examples and reference examples. The present invention is not limited by the following examples as far as these examples are within the gist of the present invention. Unless otherwise indicated, “part(s)” or “%” in the text is on a mass basis.

### Example 1

A recording ink 1 according to Example 1 was prepared as follows. At first, a mixture containing 10 parts of cyan pigment (C. I. Pigment Blue 15:3, manufactured by CLARIANT CO., LTD.), 6 parts of glycerin, 10 parts of a styrene/acrylic acid-based resin dispersant, and 74 parts of water was dispersed at 1,500 rpm for 12 hours using a sand mill manufactured by KANEDA SCIENTIFIC CO., LTD, thereby obtaining a pigment-dispersing solution 1. In the sand mill, zirconia beads of 0.6 mm in diameter were used and the filling rate in a pot was 70%. The styrene/acrylic acid-based resin dispersant used was one having a copolymerization ratio of 70:30, Mw=8,000, and an acid value of 170. The styrene/acrylic acid-based resin dispersant was previously added with water and potassium hydrate having the above acid value and then the whole was stirred at 80° C. to be turned into an aqueous solution to be used. The resulting pigment-dispersing solution 1 was stably dispersed with an average dispersion particle size of 120 nm and a polydispersion index of 0.16.

Next, 500 parts of the pigment-dispersing solution 1 was heated at 70° C. under nitrogen atmosphere and simultaneously stirred by means of a motor while each of three loading solutions was gradually added respectively, followed by allowing polymerization for 5 hours. The respective loading solutions are: a hydrophobic monomer including 28.5 parts of methyl methacrylate; a mixture solution containing a hydrophilic monomer including 4.3 parts of p-sodium styrenesulfonate and 30 parts of water; and a mixture solution containing a polymerization initiator including 0.05 parts of potassium persulfate and 30 parts of water. The resulting dispersing solution was 10-fold diluted in water and then subjected to centrifugal separation at 5,000 rpm for 10 minutes to remove aggregated components. Subsequently, the resultant was further subjected to centrifugal separation at 12,500 rpm for 2 hours, thereby resulting in a colorant-dispersing product 1 as a sediment.

The colorant-dispersing product 1 was dispersed in water and then centrifuged at 12,000 rpm for 60 minutes. The resulting sediment was re-dispersed in water and then dried, followed by the observation with a scanning electron microscope JSM-6700 (manufactured by JAPAN HITECH CO., LTD.) at a magnification of 50,000 times. As a result, it was observed that resin fine particles were fixed on the surface of the pigment in the colorant-dispersing product 1. Furthermore, the configurations of other colorants described below in this example were also observed by the same procedure, respectively.

The colorant-dispersing product 1 was prepared so as to be of 4% in concentration in ink by mixing with the components described below and then subjected to filtration under pressure through a membrane filter having a pore size of 2.5 μm. Then, the resultant was provided as aqueous ink A of this example. Furthermore, the total amount of ink was added with water so as to be adjusted to 100 parts. The same procedure was conducted on other inks described below.

7 parts of glycerin

5 parts of diethylene glycol

7 parts of trimethylolpropane

0.2 parts of Acetylenol EH (commercial name: manufactured by Kawaken Fine Chemicals Co., Ltd.)

Balance of ion-exchanged water

### Example 2

A colorant-dispersing product was obtained by the same way as that of Example 1, except that 4.3 parts of p-sodium styrenesulfonate was replaced with 2.0 parts of p-sodium styrenesulfonate. Furthermore, the colorant-dispersing product thus obtained was used and aqueous ink B was then obtained by the same way as that of Example 1.

### Example 3

A colorant-dispersing product was obtained by the same way as that of Example 1, except as follows. In place of the mixture solution including 28.5 parts of methyl methacrylate, 4.3 parts of p-sodium styrenesulfonate, and 30 parts of water, a mixture solution including 40.5 parts of methyl methacrylate, 12.9 parts of p-sodium styrenesulfonate, and 90 parts. of water provided as monomer components was used. Furthermore, the colorant-dispersing product thus obtained was used and aqueous ink C was then obtained by the same way as that of Example 1.

### Example 4

A colorant-dispersing product was obtained by the same way as that of Example 1, except as follows. In place of the mixture solution including 28.5 parts of methyl methacrylate, 4.3 parts of p-sodium styrenesulfonate, and 30 parts of water, a mixture solution including 54 parts of methyl methacrylate, 17 parts of p-sodium styrenesulfonate, and 120 parts of water provided as monomer components was used. Furthermore, the colorant-dispersing product thus obtained was used and aqueous ink D was then obtained by the same-way as that of Example 1.

### Example 5

A colorant-dispersing product was obtained by the same way as that of Example 1, except that the mixture solution including 4.3 parts of p-sodium styrenesulfonate and 30 parts of water was replaced with a mixture solution including 4.3 parts of p-sodium styrenesulfonate, 1.2 parts of sodium acrylate, and 30 parts of water. Furthermore, the colorant-dispersing product thus obtained was used and aqueous ink E was then obtained by the same way as that of Example 1.

### Reference Example

A colorant-dispersing product was obtained by the same way as that of Example 1, except that 4.3 parts of p-sodium styrenesulfonate was replaced with 0.4 parts of p-sodium styrenesulfonate. Furthermore, the colorant-dispersing product thus obtained was used and aqueous ink F was then obtained by the same way as that of Example 1.

(Characteristics of Colorant-Dispersing Product)

Each of the colorant-dispersing products obtained from Examples 1 to 5 and Reference Example as described above was observed, and various physical properties thereof were measured and evaluated on the basis of criteria described below, by the respective methods described below. Then, the results thus obtained were listed in Table 1. As shown in Table 1, each of the colorant-dispersing products of the respective examples showed good observations and was identified as one excellent in dispersibility by itself.

<Observation/Dotting Property>

Each of the colorant-dispersing product was dispersed in water and dried, and was then observed by a scanning electron microscope JSM-6700 (manufactured by JAPAN HITECH CO., LTD.) at 50,000 times magnification. If the state that the resin fine particle, which was smaller than the colorant, fixed on the colorant was observed, then the observation was evaluated as “o”. If it was not observed, then the observation was evaluated as “x”. In addition, if the dotting of resin fine particles was observed, then the observation was evaluated as “o”. On the other hand, if the state that the resin fine particles were localized or unevenly fixed was observed, then the observation was evaluated as “x”.

<Surface Functional Group Density of Sulfonic Group>

The surface functional group density of a sulfonic group with respect to the colorant-dispersing product was obtained as follows. At first, each colorant-dispersing product was dispersed in water. The resulting water dispersion medium was added with hydrochloric acid up to pH 2 or less to precipitate the dispersible colorant with acid. Subsequently, the precipitate was spun down by a centrifugal separator at 20,000 rpm for 1 hour and the resulting sediment was then collected, followed by drying to obtain a sediment 1. The sediment 1 was subjected to extraction with a Soxhlet extractor using tetrahydrofuran (THF) as an extraction solvent to extract a resin component. The solvent was distilled off, thereby obtaining the resin component. The resin component was dissolved in dimethyl sulfoxide (DMSO) and the composition of the resin component was then identified by pyrolysis gas chromatography. Furthermore, a NMR measurement was conducted to calculate the composition ratio from integral values of signals, followed by calculating the amount of sulfonic acid A (μmol/g) per gram of the resin from the composition ratio. Subsequently, the ratio B of the resin to the sediment 1 was calculated using a differential thermogravimetric analyzer (METLLER TGA/SDTA 851). From both the amount of sulfonic acid (A) and the ratio (B) of the resin to the sediment 1, which were obtained by the above methods, the surface functional group density of a sulfonic group was determined from the following equation:

Surface Functional Group Density of Sulfonic Acid
(μmol/g)=A×B
<Average Particle Size>

Each colorant-dispersing product was subjected to the measurement with a dynamic light scattering method using ELS-8000 manufactured by OTSUKA ELECTRONICS CO., LTD., and a cumulant average value was then defined as an average particle size.

<Independent Dispersion Stability>

An 8% water-dispersion solution of each colorant-dispersing product was placed in a glass bottle and then sealed off, followed by storing at 60° C. for 3 months. The product was evaluated as “A” when variation in average particle size was 10 nm or less with respect to the initial average particle size; “B” when variation in average particle size was 20 nm or less; and “C” when variation in average particle size was 20 nm or more or when the sediment was observed.

Table 1: Evaluation Results for Colorant-Dispersing Products

TABLE 1

| | | Surface | | |
|---|---|---|---|---|
| | | functional | | |
| | Observation/ | group density of | Average | Independent |
| | dotting | sulfonic acid | particle | dispersion |
| | property | (μmol/g) | size (nm) | stability |
| Example 1 | o | 220 | 140 | A |
| Example 2 | o | 100 | 140 | B |
| Example 3 | o | 470 | 145 | A |
| Example 4 | o | 550 | 145 | A |
| Example 5 | o | 220 | 140 | A |
| Reference | o | 50 | 140 | B |
| Example | | | | |

(Evaluation on Aqueous Ink-Jet Recording Ink)

Each of the aqueous inks A to F obtained by the above method was used to print on a recording medium with an ink-jet recording apparatus. The printed product thus obtained was evaluated. The ink-jet recording apparatus used was BJS 700 (manufactured by CANON INC.) and each of the aqueous inks A to F was then injected into an ink tank of cyan, followed by carrying out image formation. Subsequently, the printed product printed under the above conditions were evaluated for abrasion resistance, image density, and discharge stability as described below and the results were listed in Table 2, respectively. As shown in Table 2, it was confirmed that each of the aqueous inks of the respective examples had good discharge stability and an image formed by the corresponding ink showed excellent abrasion resistance.

<Discharge Stability>

For evaluating the discharge stability, a predetermined text was continuously printed for 300 sheets. The initial printed product and the last printed product were compared and defined by visual observation

A: Without streak, unevenness, or the like and no difference between the initial and the last was observed.

B: Streak, unevenness, and kink were observed slightly but no problem was found in printing.

C: Substantial decrease in quality was observed or printing was impossible.

<Abrasion Resistance>

The abrasion resistance of the printed product was evaluated such that a printed portion was rubbed five times with lens-cleaning paper being weighted 40 g/cm² and then the confusion of the printed portion was observed by visual observation, followed by evaluating with criteria described below.

A: Neither confusion of printing nor stain on a whiteness portion caused by rubbing was observed.

B: Almost no confusion of printing and almost no stain on a whiteness portion caused by rubbing were observed, which were negligibly small.

C: Large confusion of printing and stain on a whiteness portion caused by rubbing were observed.

<Image Density>

The evaluation on image density of the printed product was carried out such that a color text was printed on CANON PPC paper using each ink and the image density of the text was then measured after one day from the printing. The evaluation was based on the following criteria:

A: The OD value of the printed product was 0.85 or more.

B: The OD value of the printed product was 0.75 or more but less than 0.85.

C: The OD value of the printed product was less than 0.75.

TABLE 2
Evaluation results for ink

| | Discharge | Abrasion | Image |
|---|---|---|---|
| | stability | resistance | density |
| Example 1 | A | A | A |
| Example 2 | A | A | A |
| Example 3 | A | A | B |
| Example 4 | A | A | A |
| Example 5 | A | A | A |
| Reference | B | A | A |
| Example | | | |

As described above, each of the dispersible colorants of the respective examples was excellent in dispersion stability. In addition, the aqueous ink of each example was excellent in discharge stability and abrasion resistance. Furthermore, the aqueous ink of each of Examples 1, 2, 4, and 5 was also excellent in image density in addition to discharge stability and abrasion resistance.

This application claims priority from Japanese Patent Application No. 2004-184038. filed on June 22, 2004, which is hereby incorporated by reference herein.

What is claimed is:

1. A dispersible colorant, comprising a colorant and a chargeable resin pseudo fine particle having a sulfonic group, which is smaller than the colorant, characterized in that
the sulfonic group of the dispersible colorant has a surface functional group density of 100 μmol/g or more.

2. The dispersible colorant according to claim 1, wherein the sulfonic group of the dispersible colorant has a surface functional group density of 100 μmol/g or more to 500 μmol/g or less.

3. The dispersible colorant according to claim 1, wherein the plural chargeable resin pseudo fine particles are dotted and fix on the colorant.

4. A dispersible colorant according to claim 1, wherein the dispersible colorant has acidic groups on the surface of the colorant and the acidic groups are at least sulfonic acid and carbonic acid.

5. The dispersible colorant according to claim wherein the chargeable resin pseudo fine particle having the sulfonic group comprises a copolymer composed of at least one hydrophobic monomer and a hydrophilic monomer having at least a sulfonic group.

6. A method of manufacturing the dispersible colorant according to claim 1, characterized by comprising the step of subjecting a radical polymerizable monomer to aqueous precipitation polymerization in a dispersion aqueous solution of a colorant, thereby allowing a chargeable resin pseudo fine particle having a sulfonic group to fix on the colorant.

7. An aqueous ink, characterized by comprising the dispersible colorant according to claim 1.

8. An ink tank, characterized by storing the aqueous ink according to claim 7.

9. An ink-jet recording apparatus, characterized in that
an ink-jet recording image is formed using the aqueous ink according to claim 7.

10. An ink-jet recording method, characterized by comprising-forming an image by an ink-jet recording apparatus using the aqueous ink according to claim 7.

11. An ink-jet recording image, characterized by being formed by an ink-jet recording apparatus using the aqueous ink according to claim 7.
